(19) United States
(12) Patent Application Publication
(10) Pub. No.: US 2026/0258900 A1
(43) Pub. Date: Sep. 3, 2026

(54) DOORBELL MOUNTING BRACKET

(71) Applicant: SimpliSafe, Inc., Boston, MA (US)

(72) Inventors: Jingwei Dang, Millbury, MA (US); Bobby McLaughlin, Natick, MA (US); Patrick Murphy, Somerville, MA (US); Rubal Verma, Westford, MA (US)

(21) Appl. No.: 19/444,316

(22) Filed: Jan. 9, 2026

Related U.S. Application Data
(60) Provisional application No. 63/764,631, filed on Feb. 28, 2025.

(51) Int. Cl. F16M 13/02

(52) U.S. Cl. CPC F16M 13/02

(57) ABSTRACT

A bracket assembly is provided for mounting an electronic doorbell to a surface. The bracket assembly includes at least one bracket that has one or more features for customizing and/or improving mounting of the electronic doorbell to the surface.

### BACKGROUND

Electronic doorbells are commonly used to monitor an area near a door or other entry into a building as well as to allow a visitor to announce their presence. Such doorbells are often mounted to a wall or other surface with a mounting bracket near the entry point, e.g., in a place apparent to a visitor and convenient to interact with.

### SUMMARY OF THE DISCLOSURE

In one aspect of the present disclosure, a bracket assembly comprises a first bracket and a second bracket. The first bracket has a first body including: a first side for attachment to a doorbell assembly, the first side extending along a first plane; and a second side opposed from the first side, the second side extending along a second plane not parallel to the first plane and being angled relative to the first plane in a first direction. The second bracket has a second body including: a first side for attachment to a structure, the first side of the second body extending along a third plane; and a second side opposed from the first side of the second body, the second side of the second body extending along a fourth plane not parallel to the third plane and being angled relative to the third plane in a second direction, such that upon installation of the doorbell assembly on the structure the second direction is transverse to the first direction.

The second side of the first body may be for attachment to the second side of the second body. Upon attachment of the first body to the second body, the second plane may be parallel to the fourth plane. The second side of one of the first body or the second body may include an annular outer rim and the second side of the other of the first body or the second body may include an annular recess having a shape and dimensions corresponding to the annular outer rim to support nesting of the first bracket with the second bracket in which the annular recess receives the annular outer rim.

Upon installation of the doorbell assembly on the structure the second direction may be perpendicular to the first direction.

At least one of the first body or the second body may be wedge shaped.

Each of the first body and the second body defines a thickness between the first and second sides thereof. The thickness of one of the first body or the second body may be greater at a first longitudinal edge thereof than at second longitudinal edge thereof. The thickness of the other of the first body or the second body may be greater at a first lateral edge thereof than at second lateral edge thereof.

In another aspect of the present disclosure, a bracket comprises a body including a member and a recess defined by the member and at least two outer walls of the body, in which to stow excess wire connecting to a doorbell assembly.

A first side of the body may extend along a first plane, and a second side of the body opposed from the first side may extend along a second plane not parallel to the first plane and being angled relative to the first plane in a first direction.

A slot may be formed in the body proximate to the recess, the slot for routing the wire through the bracket to the doorbell assembly.

In yet another aspect of the present disclosure, a bracket assembly comprises a bracket and a plate. The bracket has a body including a boss extending from the body in a first direction. The boss includes a distal end compressible in a second direction different than the first direction. The plate is provided on which to mount the body. The plate includes an opening in which to receive the distal end of the boss to secure the body to the plate using friction between the boss and the plate surrounding the opening. The opening in the plate has a same or smaller dimension in the second direction as the distal end of the boss.

A first side of the body may extend along a first plane, and a second side of the body opposed from the first side may extend along a second plane not parallel to the first plane and being angled relative to the first plane in a first direction.

A slit may be formed in the distal end of the boss to provide compressibility of the distal end.

A pair of opposed slits may be formed in the distal end of the boss to provide compressibility of the distal end.

The body may comprise a plurality of bosses that are received in corresponding openings in the plate. The plurality of bosses may be spaced apart from one another in a direction perpendicular to the first direction.

The plate may be a body of a second bracket or a component of a doorbell assembly.

In still another aspect of the present disclosure, a bracket assembly comprises a bracket and an adapter. The bracket has a body including an annular outer rim. The adapter includes an annular recess having a shape and dimensions corresponding to the annular outer rim of the body to support nesting of the bracket with the adapter in which the recess receives the annular outer rim.

A first side of the body may extend along a first plane, and a second side of the body opposed from the first side may extend along a second plane not parallel to the first plane and being angled relative to the first plane in a first direction.

The adapter may be a body of a second bracket.

### BRIEF DESCRIPTION OF THE DRAWINGS

Additional examples of the disclosure, as well as features and advantages thereof, will become more apparent by reference to the description herein taken in conjunction with the accompanying drawings which are incorporated in and constitute a part of this disclosure. The figures are not necessarily drawn to scale. Aspects of the present disclosure are described with reference to the following drawings in which numerals reference like elements, and in which:

FIGS. 1 and 2 are perspective views of a bracket in accordance with the present disclosure;

FIGS. 3 and 4 are plan views of the bracket of FIGS. 1 and 2;

FIGS. 5 and 6 are perspective views of a bracket in accordance with the present disclosure;

FIGS. 7 and 8 are plan views of the bracket of FIGS. 1 and 2;

FIGS. 9 and 10 are exploded views of a bracket assembly for mounting a doorbell assembly to a structure in accordance with the present disclosure;

FIGS. 11 and 12 are assembled views of the bracket and doorbell assemblies of FIGS. 9 and 10;

FIG. 13 is an enlarged view illustrating select components of one of the brackets of the bracket assembly of FIGS. 9-12;

FIG. 14 is an exploded view showing an aspect of the present disclosure;

FIGS. 15 and 16 are assembled views of bracket assemblies for mounting doorbell assemblies in accordance with the present disclosure;

FIGS. 17-19 are exploded, side, and bottom views, respectively, of a bracket assembly for mounting a doorbell assembly to a structure in accordance with the present disclosure; and

FIGS. 20 and 21 are schematic views showing exemplary positions of a bracket assembly that is mounting a doorbell assembly to a structure adjacent to an entryway in accordance with the present disclosure.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of the examples described herein is thereby intended.

Electronic doorbells may include a camera, a microphone, and a speaker so that a person interacting with the doorbell can communicate with a user of an electronic device that is associated with the doorbell, such as a smartphone. Brackets may be provided to mount such doorbells to a structure, which may be a wall surface adjacent to a door or other entryway. Alignment issues may be encountered when attempting to mount the bracket to an angled structure, such as beveled siding, or to a structure that is not adjacent or parallel to the entryway, resulting in a non-optimal field of view (viewing area) for the doorbell camera.

The present disclosure provides solution(s) for mounting an electronic doorbell to a surface using one or more brackets, such that the field of view of the doorbell camera can be optimized. Solution(s) are also provided for stowing excess wire to be provided to an electronic doorbell. Moreover, solution(s) are provided for improving mounting of an electronic doorbell using one or more brackets.

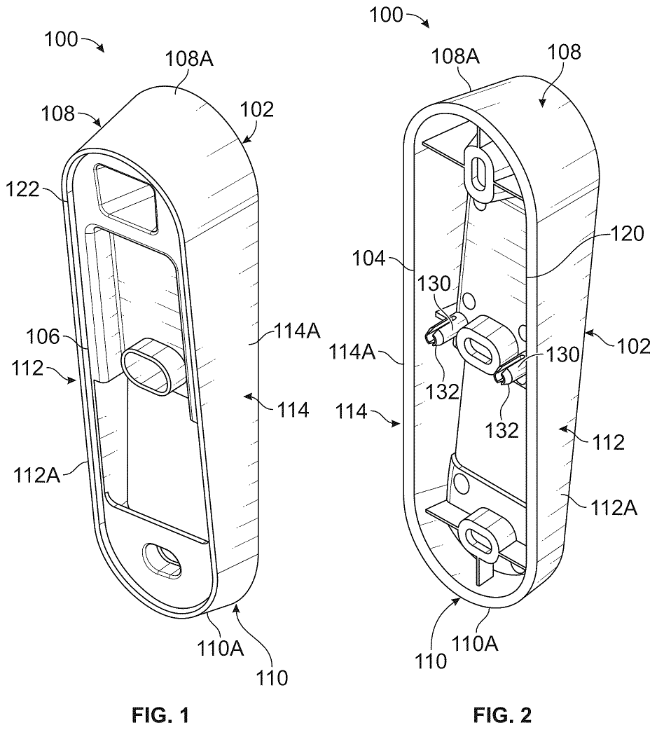

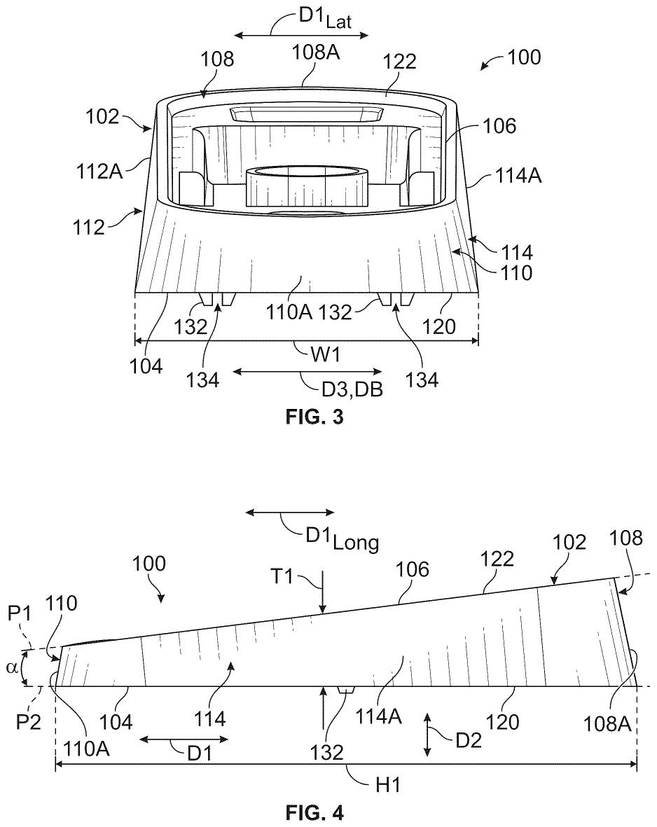

With reference now to FIGS. 1-4, a bracket 100 according to embodiments is shown for mounting a doorbell assembly to a structure, such as a wall surface near a door or other entryway. The bracket 100 shown in FIGS. 1-4 may also be referred to herein as a first bracket, a second bracket, an up/down bracket, a plate, and/or an adapter. The bracket 100 includes a body 102 having a first side 104, a second side 106 opposed from the first side 104, a first longitudinal end 108 defining a first longitudinal edge 108A, a second longitudinal end 110 defining a second longitudinal edge 110A, a first lateral end 112 defining a first lateral edge 112A, and a second lateral end 114 defining a second lateral edge 114A. A longitudinal direction D1_{Long} of the bracket 100 extends in a direction of elongation of the body 102, which aligns with a height H1 of the body 102, and a lateral direction D1_{Lat} of the bracket 100 extends in a direction of shortening of the body 102, which is perpendicular to the longitudinal direction D1_{Long} and aligns with a width W1 of the body 102, see FIGS. 3 and 4. A thickness T1 of the body 102 is defined between the first and second sides 104, 106 thereof.

According to embodiments, the body 102 is wedge shaped, as the thickness T1 of the body 102 at the first longitudinal end 108 is greater than the thickness T1 of the body 102 at the second longitudinal end 110, see FIG. 4. This wedge shape of the bracket 100 results in the first side 104 of the body 102 extending along a first plane P1 and the second side 106 of the body 102 extending along a second plane P2, wherein the second plane P2 is not parallel to the first plane P1 and is angled at an angle a relative to the first plane P1 in a first direction D1, see FIG. 4. According to embodiments, the angle a may be between 3-20 degrees, and is preferably between 5 -15 degrees. According to an exemplary working embodiment, the angle a is 7 degrees. The first direction D1 may be parallel to the longitudinal direction D1_{Long} of the body 102. It is noted that the first and second planes may also be referred to herein as third and fourth planes, respectively, depending on the configuration of a bracket assembly that is being used to mount a doorbell assembly to a surface.

The body 102 of the bracket 100 has an obround shape, defined by the rounded first and second longitudinal ends 108, 110 and the straight first and second lateral ends 112, 114 of the body 102. The longitudinal and lateral ends 108, 110, 112, 114 may be tapered such that the footprint of the body 102 at the second side 106 is smaller than the footprint of the body 102 at the first side 104, see FIGS. 3 and 4.

According to embodiments, the longitudinal and lateral edges 108A, 110A, 112A, 114A of the body 102 may cooperate to form first and second annular outer rims 120, 122 formed in the respective first and second sides 104, 106 of the body 102, see FIGS. 1 and 2. The annular outer rims 120, 122 may extend continuously around a perimeter of the body 102 at the respective first and second sides 104, 106 thereof. Either or both of the annular outer rims 120, 122 may be used for nesting the bracket 100 with an adapter when the bracket 100 is being used to mount a doorbell assembly to a structure, as will be discussed in detail herein.

As shown most clearly in FIG. 2, according to embodiments, a pair of bosses 130 extend from the body 102 in a second direction D2, wherein the second direction D2 coincides with the thickness T1 of the body 102, see FIG. 4. With reference additionally to FIGS. 3 and 4, the bosses 130 are spaced apart from one another in a direction DB perpendicular to the first direction D1. Each of the bosses 130 includes a distal end 132 that is compressible in a third direction D3, wherein the third direction D3 is different than the second direction D2 and may be perpendicular to the second direction D2. The compressibility of the distal ends 132 of the bosses 130 may be effected by at least one slit 134 formed in the distal ends 132 of the bosses 130, as most clearly shown in FIG. 3. In the exemplary embodiment shown, a pair of opposed slits 134 are formed in the distal ends 132 of the bosses 130, although additional or fewer slits may be utilized. Moreover, additional or fewer bosses may be employed in the body 102 of the bracket 100 as desired. The boss(es) 130 may be utilized to when mounting the bracket 100 to a plate, as will be discussed in detail herein.

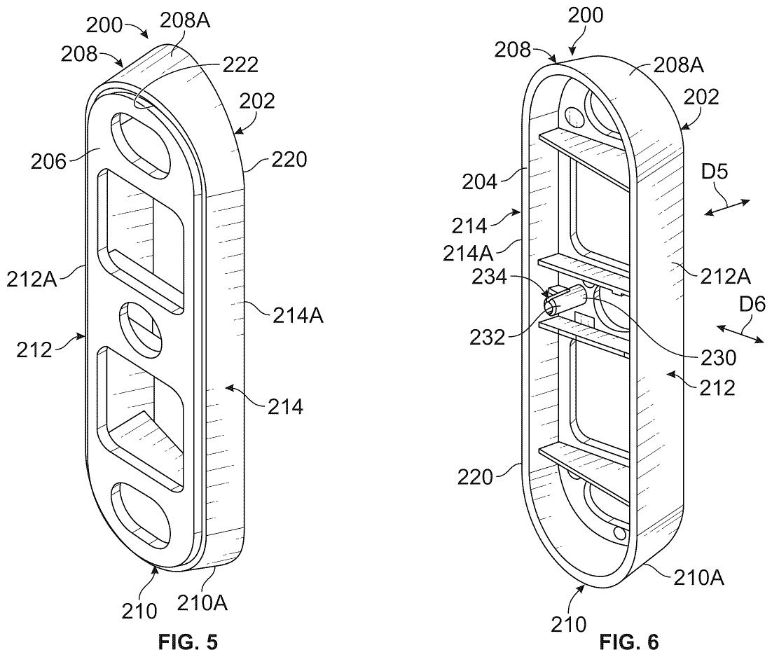

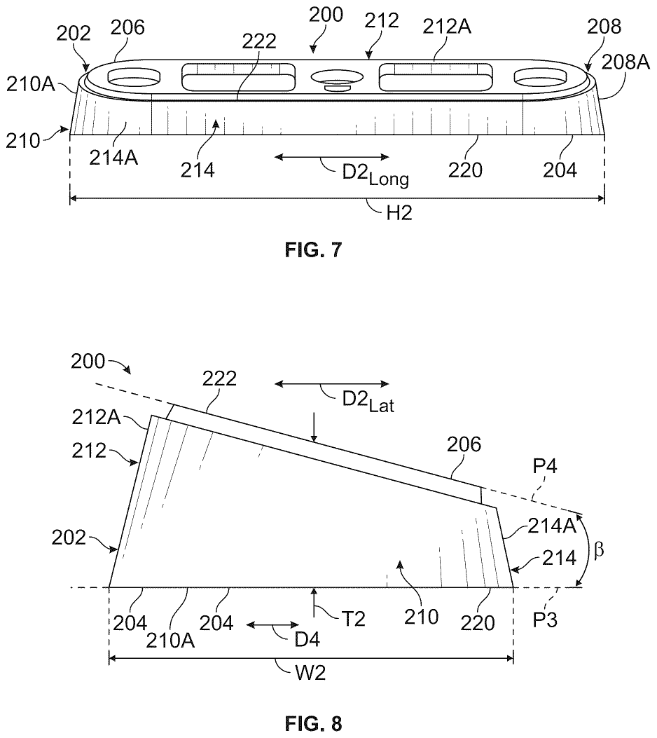

With reference now to FIGS. 5-8, another bracket 200 according to embodiments is shown for mounting a doorbell assembly to a structure, such as a wall surface near a door or other entryway. As will be discussed herein, the bracket 200 may be used with other devices, such as the bracket 100, for mounting a doorbell assembly to a structure. The bracket 200 shown in FIGS. 5-8 may also be referred to herein as a first bracket, a second bracket, a left/right bracket, a plate, and/or an adapter. The bracket 200 includes a body 202 having a first side 204, a second side 206 opposed from the first side 204, a first longitudinal end 208 defining a first longitudinal edge 208A, a second longitudinal end 210 defining a second longitudinal edge 210A, a first lateral end 212 defining a first lateral edge 212A, and a second lateral end 214 defining a second lateral edge 214A. A longitudinal direction D2_{Long} of the bracket 200 extends in a direction of elongation of the body 202, which aligns with a height H2 of the body 202, and a lateral direction D2_{Lat} of the bracket 200 extends in a direction of shortening of the body 202, which is perpendicular to the longitudinal direction D2_{Long} and aligns with a width W2 of the body 202, see FIGS. 7 and 8. A thickness T2 of the body 202 is defined between the first and second sides 204, 206 thereof.

According to embodiments, the body 202 is wedge shaped, as the thickness T2 of the body 202 at the first lateral end 212 is greater than the thickness T2 of the body 202 at the second lateral end 214, see FIG. 8. This wedge shape of the bracket 200 results in the first side 204 of the body 202 extending along a third plane P3 and the second side 206 of the body 202 extending along a fourth plane P4, wherein the fourth plane P4 is not parallel to the third plane P3 and is angled at an angle β relative to the third plane P3 in a fourth direction D4, see FIG. 8. According to embodiments, the angle β may be between 3-30 degrees, and is preferably between 5-20 degrees. According to an exemplary working embodiment, the angle β is 15 degrees. The fourth direction D4 may be parallel to the lateral direction D2_{Lat} of the body 202. It is noted that the third and fourth planes may also be referred to herein as first and second planes, respectively, depending on the configuration of a bracket assembly that is being used to mount a doorbell assembly to a surface.

The footprint of the bracket 200 has an obround shape, defined by the rounded first and second longitudinal ends 208, 210 and the straight first and second lateral ends 212, 214 of the body 202. The longitudinal and lateral ends 208, 210, 212, 214 may be tapered such that the footprint of the body 202 at the second side 206 is smaller than the footprint of the body 202 at the first side 204, see FIGS. 7 and 8.

According to embodiments, the longitudinal and lateral edges 208A, 210A, and 212A, 214A of the body 202 may respectively cooperate to form an annular outer rim 220 formed in the first side 204 of the body 202 and an annular recess 222 formed in the second side 206 of the body 202, see FIGS. 5-8. The annular outer rim and recess 220, 222 may extend continuously around a perimeter of the body 202 at the respective first and second sides 204, 206 thereof. Either or both of the annular outer rim and recess 220, 222 may be used for nesting the bracket 200 with an adapter when the bracket 200 is being used to mount a doorbell assembly to a structure, as will be discussed in detail herein.

As shown most clearly in FIG. 6, according to embodiments, a boss 230 extend from the body 202 in a fifth direction D5, wherein the fifth direction D5 coincides with the thickness T2 of the body 202. The boss 230 includes a distal end 232 that is compressible in a sixth direction D6, wherein the sixth direction D6 is different than the fifth direction D5 and may be perpendicular to the fifth direction D5. The compressibility of the distal end 232 of the boss 230 may be effected by at least one slit 234 formed in the distal end 232 of the boss 230. In the exemplary embodiment shown, a pair of opposed slits 234 are formed in the distal end 232 of the boss 230, although additional or fewer slits may be utilized. Moreover, additional bosses may be employed in the body 202 of the bracket 200 as desired. The boss(es) 230 may be utilized to when mounting the bracket 200 to a plate, as will be discussed in detail herein.

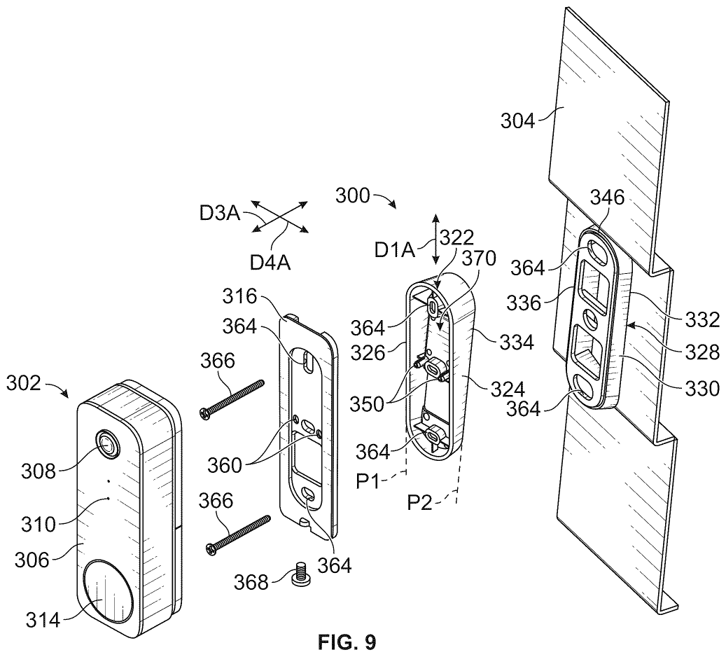

Turning now to FIGS. 9-14, an exemplary configuration of a bracket assembly 300 is shown for mounting a doorbell assembly 302 to a structure 304, which may be, for example, a wall surface adjacent to a door or other entryway. The exemplary doorbell assembly 302 shown in FIGS. 9-14 comprises an electronic doorbell 306, which may include conventional components including a camera 308, a microphone 310, a speaker 312 (not shown in FIGS. 9-14, but see FIG. 19), and a pressable doorbell button 314. It is noted that the configuration of the electronic doorbell components is exemplary and other component configurations are possible, including using different components and/or placing the components in different locations. The doorbell assembly 302 also comprises a plate 316, which is coupled to a backside of the electronic doorbell 306. The plate 316 may also be referred to herein as an adapter.

In the exemplary embodiment shown, the bracket assembly 300 includes a first bracket 322 comprising a first body 324 having a first side 326 for attachment to the doorbell assembly 302, and a second bracket 328 comprising a second body 330 having a first side 332 for attachment to the structure 304. The first bracket 322 may be the bracket 100 described above, and the second bracket 328 may be the bracket 200 described above, although it is noted that this configuration could be reversed, i.e., the bracket for attachment to the doorbell assembly 302 may be the bracket 200 described above, and the bracket for attachment to the structure 304 may be the bracket 100 described above.

The first side 326 of the first body 324 extends along a first plane P1, and a second side 334 of the first body 324, which is opposed from the first side 326 thereof, extends along a second plane P2 not parallel to the first plane P1 and being angled relative to the first plane P1 in a first direction DIA of the bracket assembly 300, see FIG. 9.

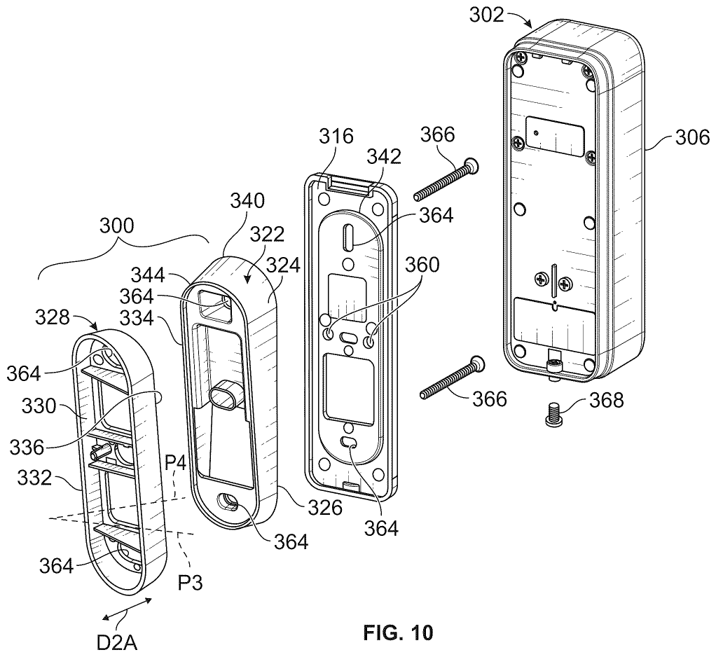

The first side 332 of the second body 330 extends along a third plane P3, and a second side 336 of the second body 330, which is opposed from the first side 332 thereof, extends along a fourth plane P4 not parallel to the third plane P3 and being angled relative to the third plane P3 as described above for the bracket 200 in a second direction D2A of the bracket assembly 300, see FIG. 10.

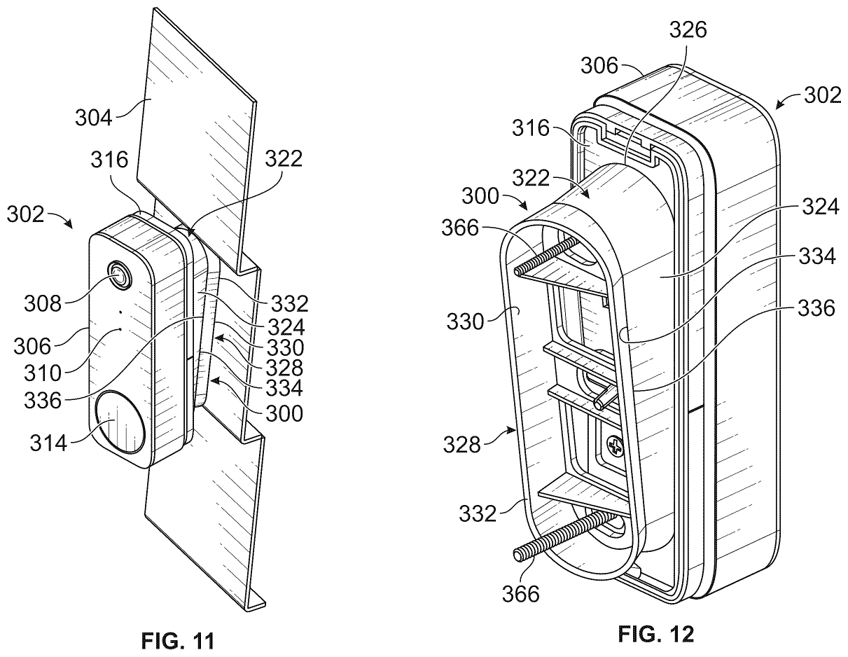

As shown in FIGS. 11 and 12, upon installation of the doorbell assembly 302 on the structure 304 using the bracket assembly 300, the second sides 334, 336 of the respective first and second bodies 324, 330 are engaged with one another, and, hence, the second plane P2 is parallel to the fourth plane P4. Moreover, upon installation of the doorbell assembly 302 on the structure 304 using the bracket assembly 300, the second direction D2A of the bracket assembly 300 is transverse to the first direction DIA of the bracket assembly 300, and may be perpendicular to the first direction DIA of the bracket assembly 300. This allows a field of view of the camera 308 of the electronic doorbell 306 to be adjusted in the first and second directions D1A, D2A of the bracket assembly 300. That is, in the exemplary embodiment shown, the wedge shape of the first bracket 322 enables adjustment of the up-down field of view of the camera 308, e.g., to account for the doorbell assembly 302 being mounted to a beveled structure 304 (which may be a beveled siding material, for example), and the wedge shape of the second bracket 328 enables adjustment of the side-to-side field of view of the camera 308, e.g., to account for the doorbell assembly 302 not being mounted immediately adjacent or parallel to the door or other entryway. Additional details in connection with this aspect with be discussed below.

With reference to FIG. 10, according to embodiments, upon engagement of the first bracket 322 to the plate 316, a first annular outer rim 340 at the first side 326 of the first body 324 is received by an annular recess 342 of the plate 316 (the plate 316 is also referred to herein as an adapter), wherein the annular recess 342 of the plate 316 has a shape and dimensions corresponding to the first annular outer rim 340 to support nesting of the first bracket 322 with the plate 316. Additionally, upon engagement of the first bracket 322 to the second bracket 328, a second annular outer rim 344 at the second side 334 of the first body 324 is received by an annular recess 346 (see FIG. 9) of the second bracket 328 (the second bracket 328 is also referred to herein as an adapter), wherein the annular recess 346 of the second bracket 328 has a shape and dimensions corresponding to the second annular outer rim 344 to support nesting of the first bracket 322 with the second bracket 328. Nesting of the first bracket 322 with the plate 316 and with the second bracket 328 aids a user in mounting of the doorbell assembly 302 to the structure 304 by preventing relative lateral and longitudinal movement between the first bracket 322 and the plate 316, and between the first bracket 322 and the second bracket 328 during the mounting process.

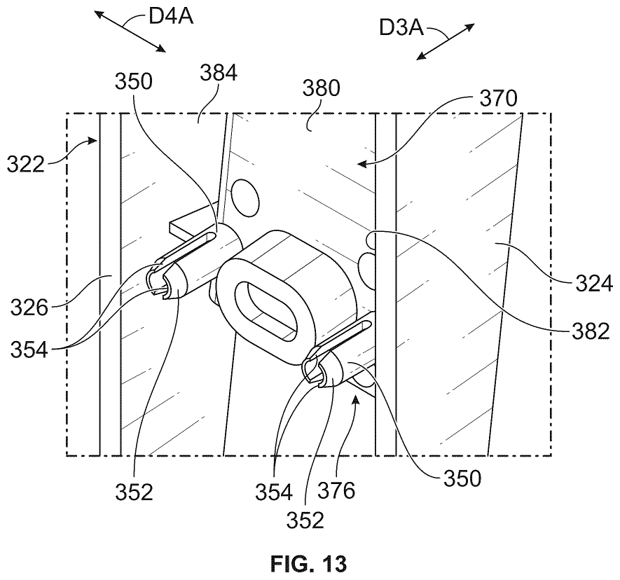

As shown most clearly in FIGS. 9 and 13, a pair of bosses 350 extend from the first body 324 in a third direction D3A of the bracket assembly 300 toward the plate 316. The bosses 350 each include distal ends 352 having a pair of opposed slits 354, which provide compressibility of the distal ends 352 of the bosses 350 in a fourth direction D4A of the bracket assembly 300, wherein the third and fourth directions D3A, D4A of the bracket assembly 300 are different from each other, and in the embodiment shown are perpendicular to one another. The plate 316 includes a corresponding pair of openings 360 in which to receive the distal ends 352 of the bosses 350. The openings 360 in the plate 316 have a same or smaller dimension in the fourth direction D4A as the distal ends 352 of the bosses 350, such that the first body 324 can be secured to the plate 316 using friction between the bosses 350 and the plate 316 surrounding the openings 360 upon insertion of the distal ends 352 of the bosses 350 into openings 360. The friction fit between the bosses 350 and the plate 316 surrounding the openings 360 further aids a user in mounting of the doorbell assembly 302 to the structure 304 by preventing relative movement between the first bracket 322 and the plate 316.

As shown in FIGS. 9, 10, and 14, the plate 316 and the first and second bodies 324, 330 each include a plurality of apertures 364 for receiving fasteners 366, e.g., screws, for the bracket assembly 300 to mount the doorbell assembly 302 to the surface 304. According to an embodiment, the fasteners 366 may be inserted through the apertures 364 in the plate 316 and the first and second bodies 324, 330 and into the structure 304 to secure these components to the structure 304. Thereafter, the electronic doorbell 306 may be attached to the plate 316 via a mounting screw 368, see FIGS. 9 and 10 and also FIG. 19.

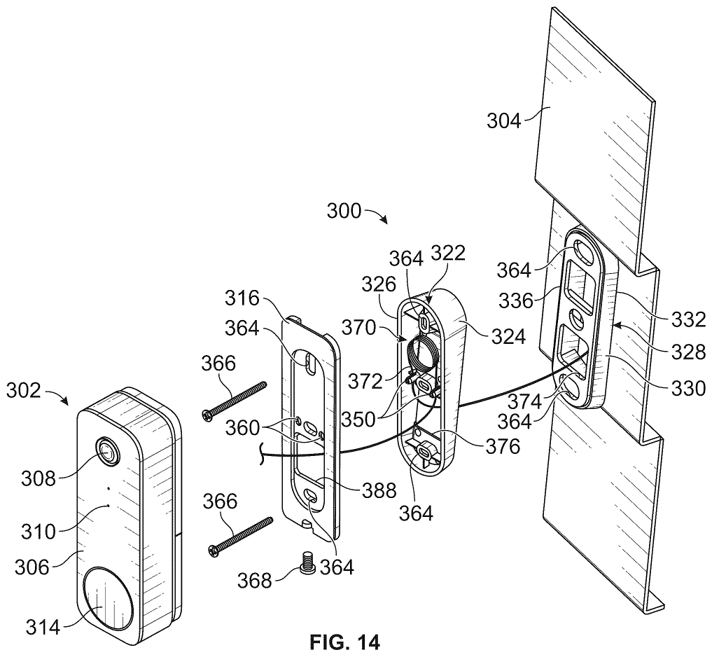

With reference to FIG. 14, according to embodiments, at least one of the first and second brackets 322, 328 may include a recess 370 for stowing excess wire 372, wherein the wire 372 extends from inside the structure 304 through the bracket assembly 300 to the electronic doorbell 306 of the doorbell assembly 302. In the exemplary embodiment shown, the wire 372 is routed from the structure 304 through a first slot 374 formed in the second body 330 of the second bracket 328, and through a second slot 376 formed in the first body 324 of the first bracket 322. As most clearly shown in FIG. 13, the recess 370 according to the exemplary embodiment shown is defined by a member 380 and a pair of outer walls 382, 384 of the first body 324, the member 380 comprising a backside wall of the first body 324 that is recessed from the first side 326 of the first body 324 by the two outer walls 382, 384. The recess 370 is proximate to the second slot 376 for providing a convenient area in which to stow the excess wire 372. The remaining wire 372 to be connected to the electronic doorbell 306 is routed through a third slot 388 formed in the plate 316 and then on to the electronic doorbell 306 for connection thereto.

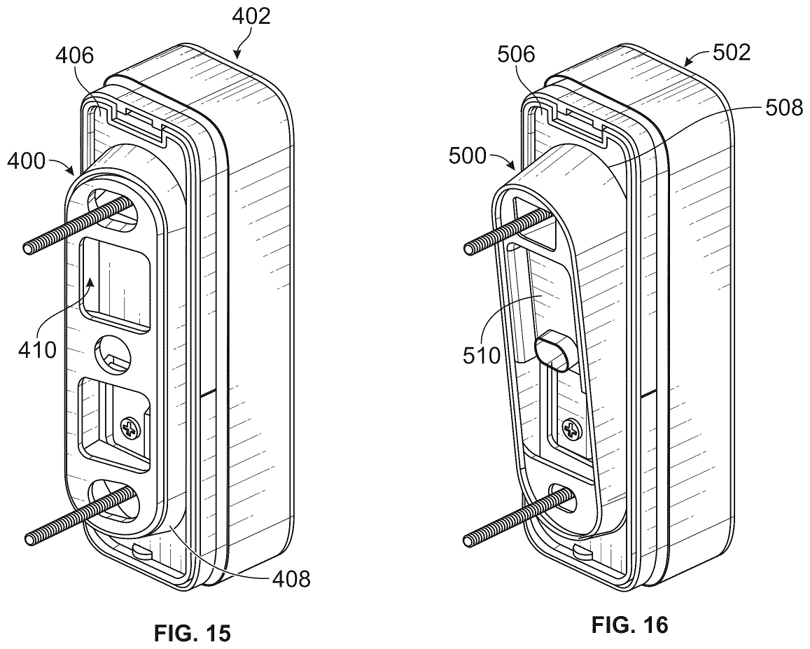

FIGS. 15-19 illustrate a number of other exemplary configurations of bracket assemblies that are used to mount doorbell assemblies to structures. These exemplary bracket assembly configurations will now be described, it being understood that other bracket assembly configurations are possible.

In FIG. 15, a single bracket 400 comprising a left/right bracket is used to mount a doorbell assembly 402 to a structure (the structure is not shown in this embodiment for better visibility of the bracket 400). The bracket 400 may be used to adjust the left/right field of view of a camera of the doorbell assembly 402. The bracket 400 may include features of the brackets described herein, including but not limited to at least one boss (see the boss 230 of FIG. 6) for being received in at least one corresponding opening in a plate 406 of the doorbell assembly 402 (see the openings 360 formed in the plate 316 shown in FIGS. 9 and 10), an annular outer rim 408 that is received by an annular recess of the plate 406 of the doorbell assembly 402 (see the annular recess 342 of the plate 316 shown in FIG. 10), and/or a recess 410 for stowing excess wire. It is noted that in the position shown in FIG. 15, the bracket 400 effects an adjustment of the left/right field of view of the doorbell camera to the left. However, prior to mounting the doorbell assembly 402 to the structure, the bracket 400 can be rotated 180 degrees, so that the left/right field of view of the doorbell camera is adjusted to the right.

In FIG. 16, a single bracket 500 comprising an up/down bracket is used to mount a doorbell assembly 502 to a structure (the structure is not shown in this embodiment for better visibility of the bracket 500). The bracket 500 may be used to adjust the up/down field of view of a camera of the doorbell assembly 502. The bracket 500 may include features of the brackets described herein, including but not limited to at least one boss (see the bosses 130 of FIG. 2) for being received in at least one corresponding opening in a plate 506 of the doorbell assembly 502 (see the openings 360 formed in the plate 316 shown in FIGS. 9 and 10), an annular outer rim 508 that is received by an annular recess of the plate 506 of the doorbell assembly 502 (see the annular recess 342 of the plate 316 shown in FIG. 10), and/or a recess 510 for stowing excess wire. It is noted that in the position shown in FIG. 16, the bracket 500 effects an adjustment of the up/down field of view of the doorbell camera in the downward direction. However, prior to mounting the doorbell assembly 502 to the structure, the bracket 500 can be rotated 180 degrees, so that the up/down field of view of the doorbell camera is adjusted in the upward direction.

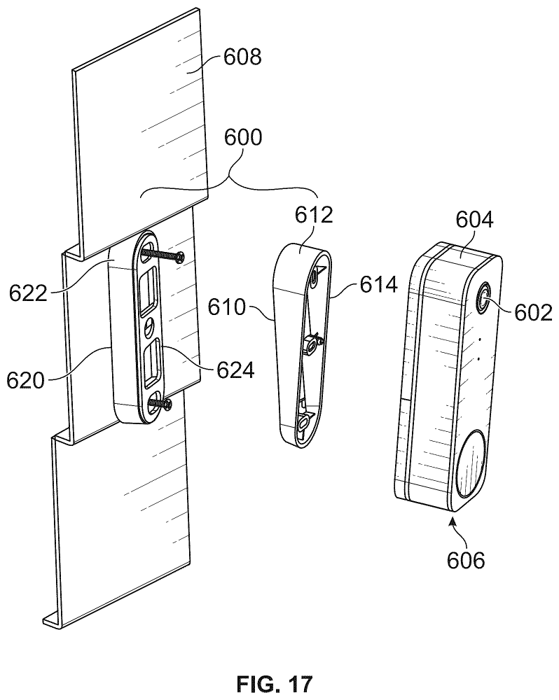

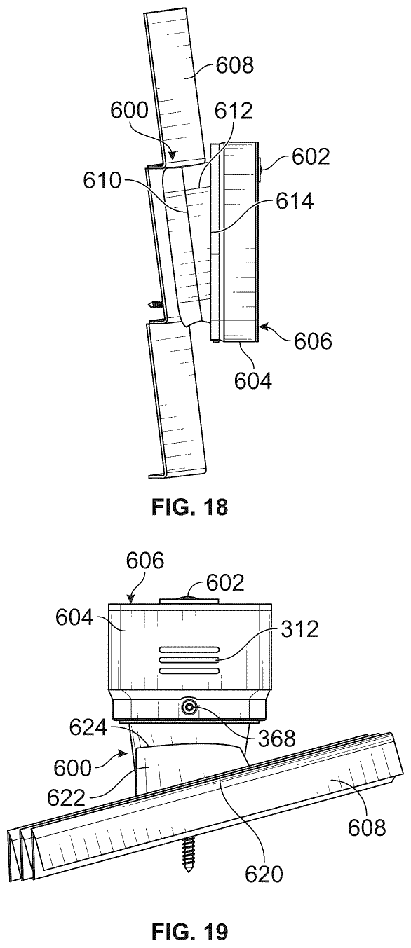

FIGS. 17-19 demonstrate how a bracket assembly 600 according to embodiments can be used to adjust the up/down and left/right fields of view of a camera 602 of an electronic doorbell 604 when the bracket assembly 600 is mounting a doorbell assembly 606 to a structure 608. FIG. 18 shows how the bracket assembly 600 can be used to adjust up/down field of view of the camera 602 when the doorbell assembly 606 is mounted to a beveled structure 608, such as a siding material, using the bracket assembly 600. Specifically, the plane on which a first side 610 of a first bracket 612 extends relative the plane on which a second side 614 of the first bracket 612 extends adjusts up/down field of view of the camera 602 to account for the non-vertical surface angle of the beveled structure 608. FIG. 19 in turn shows how the bracket assembly 600 can be used to adjust left/right field of view of the camera 602 when the doorbell assembly 606 is mounted to the structure 608 using the bracket assembly 600. Specifically, the plane on which a first side 620 of a second bracket 622 extends relative the plane on which a second side 624 of the first bracket 622 extends adjusts left/right field of view of the camera 602 to allow for the camera to be focused on an area of interest, such as in front of a door or other entryway.

The bracket assembly 600 and doorbell assembly 606 of FIG. 17-19 may have any of the features/elements of the bracket assembly 300 and doorbell assembly 302 discussed above for FIGS. 9-14, which features/elements will not be repeated herein for brevity.

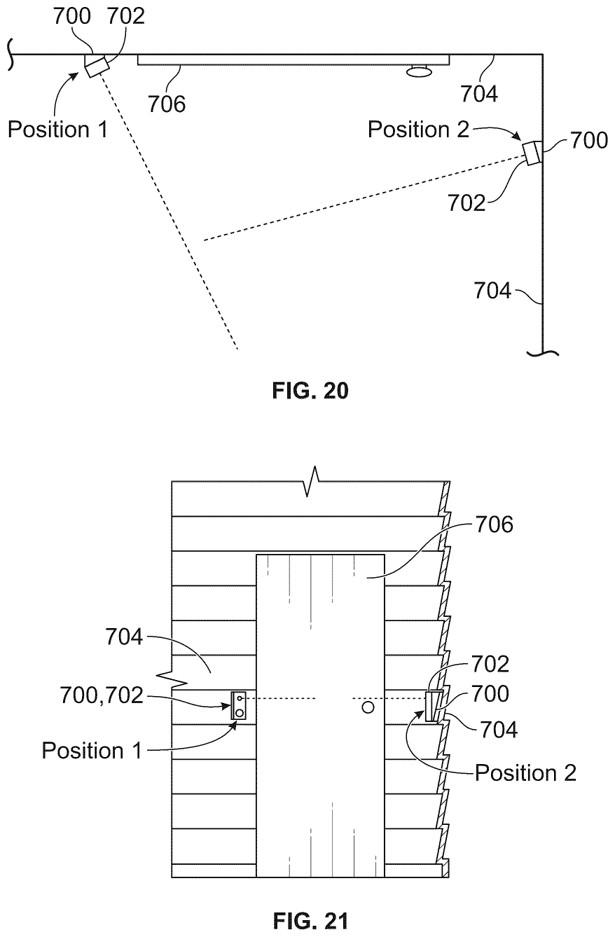

FIGS. 20 and 21 schematically illustrate select exemplary positions and configurations of a bracket assembly 700 that is used to mount a doorbell assembly 702 to a structure 704. The exemplary bracket assembly 700 of FIGS. 20 and 21 includes an up/down bracket and a left/right bracket as described herein.

In a first position shown in FIGS. 20 and 21, the bracket assembly 700 is used to mount the doorbell assembly 702 to the structure 704 such that: 1) the field of view of the doorbell camera is adjusted downwardly by the up/down bracket to account for the beveled surface of the structure 704; and 2) the field of view of the doorbell camera is adjusted in a lateral direction toward a door 706 by the left/right bracket to allow for the doorbell camera to be focused on an area of interest in front of the door 706.

In a second position shown in FIGS. 20 and 21, the bracket assembly 700 is used to mount the doorbell assembly 702 to the structure 704 such that: 1) the field of view of the doorbell camera is adjusted downward by the up/down bracket to account for the beveled surface of the structure 704; and 2) the field of view of the doorbell camera is adjusted in a lateral direction away from the door 706 by the left/right bracket to allow for the doorbell camera to be focused on the area of interest in front of the door 706.

It is noted that the positions and configurations of the bracket assembly 700 shown in FIGS. 20 and 21 are exemplary and that other positions and/or configurations of the bracket assembly 700 are possible.

Bracket assemblies disclosed herein are able to aid a user in mounting doorbell assemblies to structures while allowing for a camera of the doorbell assembly to be focused on an area of interest, such as in front of a door or other entryway. Up/down and/or left/right brackets according to embodiments can be rotated 180 degrees to allow for a bracket assembly to selectively adjust the up/down and/or left/right fields of view of the doorbell camera. Additionally, bracket assemblies disclosed herein can accommodate excess wire to be routed to doorbell assemblies. Moreover, bracket assemblies disclosed herein can prevent relative movement between components during mounting of a doorbell assembly to a structure, making the mounting process easier and more efficient.

Various concepts may be embodied as one or more methods, of which examples have been provided. The acts performed as part of a method may be ordered in any suitable way. Accordingly, examples may be constructed in which acts are performed in an order different than illustrated, which may include performing some acts simultaneously, even though shown as sequential acts in illustrative examples.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

Examples of the structures, methods, and systems discussed herein are not limited in application to the details of construction and the arrangement of components set forth in the following description or illustrated in the accompanying drawings. The structures, methods, and systems are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

### CLAUSES

A. A bracket assembly comprising:
   a first bracket having a first body including:
      first side for attachment to a doorbell assembly, the first side extending along a first plane; and
      a second side opposed from the first side, the second side extending along a second plane not parallel to the first plane and being angled relative to the first plane in a first direction; and
   a second bracket having a second body including:
      a first side for attachment to a structure, the first side of the second body extending along a third plane; and
      a second side opposed from the first side of the second body, the second side of the second body extending along a fourth plane not parallel to the third plane and being angled relative to the third plane in a second direction, such that upon installation of the doorbell assembly on the structure the second direction is transverse to the first direction.
B. The bracket assembly of clause A, wherein the second side of the first body is for attachment to the second side of the second body.
C. The bracket assembly of clause B, wherein, upon attachment of the first body to the second body, the second plane is parallel to the fourth plane.
D. The bracket assembly of clause B or C, wherein the second side of one of the first body or the second body includes an annular outer rim and the second side of the other of the first body or the second body includes an annular recess having a shape and dimensions corresponding to the annular outer rim to support nesting of the first bracket with the second bracket in which the annular recess receives the annular outer rim.
E. The bracket assembly of any of clauses A-D, wherein, upon installation of the doorbell assembly on the structure the second direction is perpendicular to the first direction.
F. The bracket assembly of any of clauses A-E, wherein at least one of the first body or the second body is wedge shaped.
G. The bracket assembly of any of clauses A-F, wherein:
   each of the first body and the second body defines a thickness between the first and second sides thereof;
   the thickness of one of the first body or the second body is greater at a first longitudinal edge thereof than at second longitudinal edge thereof; and
   the thickness of the other of the first body or the second body is greater at a first lateral edge thereof than at second lateral edge thereof.

H. A bracket comprising:
a body including:
a member; and
a recess defined by the member and at least two outer walls of the body, in which to stow excess wire connecting to a doorbell assembly.
I. The bracket of clause H, wherein a first side of the body extends along a first plane, and a second side of the body opposed from the first side extends along a second plane not parallel to the first plane and being angled relative to the first plane in a first direction.
J. The bracket of clause H or I, wherein a slot is formed in the body proximate to the recess, the slot for routing the wire through the bracket to the doorbell assembly.
K. A bracket assembly comprising:
   a bracket having a body including a boss extending from the body in a first direction, the boss including a distal end compressible in a second direction different than the first direction; and
   a plate on which to mount the body, the plate including an opening in which to receive the distal end of the boss to secure the body to the plate using friction between the boss and the plate surrounding the opening, the opening in the plate having a same or smaller dimension in the second direction as the distal end of the boss.
L. The bracket assembly of clause K, wherein a first side of the body extends along a first plane, and a second side of the body opposed from the first side extends along a second plane not parallel to the first plane and being angled relative to the first plane in a first direction.
M. The bracket assembly of clause K or L, wherein a slit is formed in the distal end of the boss to provide compressibility of the distal end.
N. The bracket assembly of any of clause K or L, wherein a pair of opposed slits are formed in the distal end of the boss to provide compressibility of the distal end.
O. The bracket assembly of any of clauses K-N, wherein:
   the body comprises a plurality of bosses that are received in corresponding openings in the plate; and
   the plurality of bosses are spaced apart from one another in a direction perpendicular to the first direction.
P. The bracket assembly of any of clauses K-O, wherein the plate is a body of a second bracket.
Q. The bracket assembly of any of clauses K-O, wherein the plate is a component of a doorbell assembly.
R. A bracket assembly comprising:
a bracket having a body including an annular outer rim;
an adapter including an annular recess having a shape and dimensions corresponding to the annular outer rim of the body to support nesting of the bracket with the adapter in which the recess receives the annular outer rim.
S. The bracket assembly of clause R, wherein a first side of the body extends along a first plane, and a second side of the body opposed from the first side extends along a second plane not parallel to the first plane and being angled relative to the first plane in a first direction.
T. The bracket assembly of clause R or S, wherein the adapter is a body of a second bracket.

Having described several examples in detail, various modifications and improvements will readily occur to those skilled in the art. Such modifications and improvements are intended to be within the scope of this disclosure. Accordingly, the foregoing description is by way of example only, and is not intended as limiting.

1. A bracket assembly comprising:
a first bracket having a first body including:
a first side for attachment to a doorbell assembly, the first side extending along a first plane; and
a second side opposed from the first side, the second side extending along a second plane not parallel to the first plane and being angled relative to the first plane in a first direction; and
a second bracket having a second body including:
a first side for attachment to a structure, the first side of the second body extending along a third plane; and
a second side opposed from the first side of the second body, the second side of the second body extending along a fourth plane not parallel to the third plane and being angled relative to the third plane in a second direction, such that upon installation of the doorbell assembly on the structure the second direction is transverse to the first direction.

2. The bracket assembly of claim 1, wherein the second side of the first body is for attachment to the second side of the second body.

3. The bracket assembly of claim 2, wherein, upon attachment of the first body to the second body, the second plane is parallel to the fourth plane.

4. (canceled)

5. The bracket assembly of claim 1, wherein, upon installation of the doorbell assembly on the structure the second direction is perpendicular to the first direction.

6. The bracket assembly of claim 1, wherein at least one of the first body or the second body is wedge shaped.

7. The bracket assembly of claim 1, wherein:
each of the first body and the second body defines a thickness between the first and second sides thereof;
the thickness of one of the first body or the second body is greater at a first longitudinal edge thereof than at second longitudinal edge thereof; and
the thickness of the other of the first body or the second body is greater at a first lateral edge thereof than at second lateral edge thereof.

8. The bracket assembly of claim 1, wherein the first body includes a member and at least two outer walls, the member and the at least two outer walls defining a recess in which to stow excess wire connecting to the doorbell assembly.

9. (canceled)

10. The bracket assembly of claim 8, wherein the first body further includes a slot proximate to the recess, the slot for routing the wire through the first bracket to the doorbell assembly.

11-20. (canceled)
